(19) United States
(12) Patent Application Publication
(10) Pub. No.: US 2006/0210344 A1
(43) Pub. Date: Sep. 21, 2006

(54) Device for delivering a printed coupon designed to equip a thermal printing mechanism in particular

(76) Inventor: Denis Montagutelli, Angers (FR)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 10/533,571

(22) PCT Filed: Oct. 7, 2003
(86) PCT No.: PCT/FR03/02934

§ 371 Date: Apr. 21, 2006

(30) Foreign Application Priority Data
Nov. 4, 2002 (FR) 02/14598

(51) Int. Cl. B41J 11/00

(52) U.S. Cl. 400/621

(57) ABSTRACT

The invention relates to a device for feeding a band (2) in order to deliver for a user a printed voucher (1) generated from said band (2), this device being arranged to co-operate with a thermal printing mechanism, such as a thermal printing mechanism. This mechanism comprises means (14) for slaving the speeds driving the band (2) during printing, jointly by the first motorised means (4) and by second motorised positive driving means (11, 12) of the band (2) arranged inside a reserve chamber (5), the implementation of said slaving means (14) being placed under the control of means (16) for detecting the position of an elastic mobile member (10) for maintaining under tension the band (2) inside the reserve chamber (5).

The field of the invention concerns devices for handling a band-type material, and more particularly for handling a rolled-up printable band. It relates to a device for feeding a printed voucher, generated from such a band after running through a printing mechanism, in particular a thermal printing mechanism.

It should be borne in mind that in the field of printing mechanisms, and more particularly thermal printing mechanisms, it is current practice to equip said mechanisms with means for delivering a printed voucher, which is separated from a rolled-up printable band. Generally speaking, devices for feeding said voucher are known, comprising mainly a chassis carrying the printing mechanism and the rolled-up band reserve, means for conveying the band from the reserve, successively to the printing mechanism then to means for separating and delivering the printed voucher, separated from the band.

A general problem to be solved lies in the space requirements and in the complexity of such devices. Indeed, they should be organised in order to carry the different motorised members which are necessary to perform automatically the printing, cutting and delivering operations of the printed voucher. To limit this space requirements problem, devices have been suggested to allow the delivery of the voucher during the printing operation. It may be referred to the documents U.S. Pat. No. 4,579,267 (TORE PLANKE) and FR2801397 (AXIOHM) which describe such devices.

However, such an arrangement raises a related problem, which lies in that an awkward or tactless user is likely to tamper with the printing of the band during delivery. Indeed, the user having access to the end of the band during printing, before separation of the voucher, it is possible to thereon or to plug the delivery mouth, with consequently at best, poor quality printing, at worst, damages to the printing mechanism, let alone damages to the voucher delivery device properly speaking.

One may deduce therefrom consequently that the solutions preferred in the field consist in organising the voucher delivery devices in order to prevent the user from accessing the band during the printing and cutting operations, by delivering the printed voucher strictly after the printing thereof and the separation thereof from the band. It is usually suggested to block such an access while providing an intermediate chamber of sufficient dimension for receiving the voucher until it has been printed completely, and to detach it from the band and to deliver it only once said printing has been completed.

Such solutions are for example described in the documents U.S. Pat. No. 5,215,393 (TOMMY WINCENT), U.S. Pat. No. 6,129,465 (ANTHONY ROSS HOYT et al.), U.S. Pat. No. 5,407,115 (DOLAN F.BLALOCK et al.) and U.S. Pat. NO. 5,407,115 (DOLAN F.BLALOCK et al.).

More particularly, the document U.S. Pat. No. 5,215,393 suggests immobilising rolls fro driving the voucher during the printing operation, so as not to authorise the delivery thereof as long as the printing operation is not completed. The document U.S. Pat. No. 6,129,465 suggest a complex mechanical device wherein the chamber for intermediate storage of the voucher is mobile between a position for receiving the printed voucher and a position for delivering said voucher.

It will also be noted that it is current practice for such a device to provided motorised means for separating the voucher, with the exception of the solution suggested by U.S. Pat. No. 5,407,115, according to which the separation of the voucher is performed manually by the user.

The consequence is finally, in the light of the general problem aforementioned to be solved, unduly increase in the space requirements and the complexity of these devices, by reason notably of the presence of the intermediate chamber for receiving the voucher during printing until the separation thereof and the delivery thereof, and/or by reason of a complexity of the active and motorised mobiles members enabling to perform the various printing, cutting and delivery operations.

The purpose of the present invention is a device intended to equip a printing mechanism, in particular a thermal printing mechanism, for a rolled-up band with a view to delivering a voucher, which has small space requirements and which prevents nevertheless the user from disturbing the printing operation as well as the delivery of the voucher.

The device suggested by the present invention is a band feeding device in order to deliver for a user a printed voucher generated from said band. This device is arranged to co-operate with a thermal printing mechanism or similar, which comprises first motorised means for driving the rolled-up printable band, from a reserve to a printing head. This device is moreover arranged in order to allow user's access to the portion of band during printing, by circulation through the delivery mouth during printing.

Such a device comprises mainly:

*) a chassis fitted with a mouth for delivering the voucher for the user and connected to the printing mechanism,

*) a chamber storing a portion of band during printing, which is interposed between the printing mechanism and the delivery mouth,

*) accessorily, a cutting member for the separation of the voucher beyond the band, in the case notably when the band reserve has not been pre-cut.

According to the present invention, such a device is mainly recognisable in that it comprises moreover means for slaving the speeds driving the band during printing, driving the band jointly by the first motorised means and by second motorised positive driving means of the band, means located inside the reserve chamber. These slaving means being means for causing simultaneous and regulated implementation of the first and second driving means relative to one another, their implementation is placed under the control of means for detecting the position of an elastic mobile member for maintaining under tension the band inside the reserve chamber.

This elastic mobility of the member maintaining the band under pressure is obtained in particular by mounting said member on the chassis by dint of recall means towards an initial start-of-cycle position, contrary to the driving thereof by the second driving means, a position which varies according to the relative driving speeds of the band, respectively by the first and by the second driving means.

It should be noted that the present invention suggests in particular positive conveying of the band by the second driving means, where of the implementation, related on the implementation of the first driving means and of the position of the member for maintaining under tension the band inside the reserve chamber, and therefore of the band length situated therein, causes the band to be evacuated beyond the second driving means without any relative slipping between said band and said second driving means, forbidding de facto any user-initiated disturbance of the conveying of the band during printing, and any floating of said band inside the reserve chamber.

It should be noted at that stage of the description that the second driving means are for example formed of a couple of rolls bearing resiliently against one another, one of which is made of relatively flexible material such as rubber-based or similar, and whereof the other is made of relatively hard material whereof the surface condition provides better friction of the paper, with identical pressure, facing the other roll.

It results from these provisions that the portion of band during printing is available to the user without altering the printing process nor the printing head, including if said user imparts undue traction to the band, it results finally that the space requirements of the device, although prohibiting any disturbance of the operation thereof in spite of the voucher offered to the user, are reduced by reason of the independence between the length of the voucher to be delivered and the capacity of the reserve chamber which, regardless of said length, may be rather small.

Besides, there results easy organisation of the chassis to support all the elements necessary to the operation of the device.

It should be noted at that stage of the description that the second motorised means are preferably composed of a motorised member such that a user should develop on the band during printing a significant traction load, reasonably impossible to cause consequent variation in length of the band inside the reserve chamber. This motorised member is for example either a continuous motor with an appropriate gear reduction system, or a stepping motor whereof the torque increases when the speed thereof decreases.

Building upon said approach, it is advantageously suggested to install the cutting member inside the reserve chamber in a fixed position relative to the mobile member maintaining the band under tension, the voucher being separated by positive driving of the band by the second motorised means towards the cutting member, opposing the elastic mobility of the member maintaining the band under tension.

The general organisation of the device of the present invention, advantageously fitted with the cut, aims more particularly at suggesting a process for delivering a voucher consisting in particular, from said slaving means, in performing the following sequential stages:

*) first of all conveying the portion of band during printing, simultaneously by the first and the second driving means towards and through the delivery mouth,

*) secondly, conveying the band at the end of the printing process by the second driving means, towards the fixed cutting member to cause the separation of the voucher, and

*) thirdly, evacuating by the second driving means of the voucher beyond the reserve chamber, while maintaining said voucher, to make it available to the user.

These provisions are such that the position detected for the member maintaining the band under pressure enables to deduce therefrom the length of printed band present in the reserve chamber. This piece of information is used for controlling the implementation of the slaving means to match the activation of the first and second driving means at the different operating stages of the device. For example, a driving speed of the band by the second driving means which is greater than or equal to a driving speed of the band by the first driving means, enables to convey under tension the band during printing towards the delivery mouth, while maintaining the band tensioning member at a position determined with respect to the cutting member, including in case of temporary stoppage of the first driving means partaking of the printing mechanism when printing the band. For example still, at the end of the printing process of the band, the second driving means may be implemented according to the information transmitted by the position detection member of the holding member, to bring it to the cutting member for the separation of the voucher to be delivered.

According to a preferred embodiment of the band tensioning member, the latter is mainly composed of an arm mounted resiliently and rotatably on the chassis, opposing a tension applied by the printed arm to the arm under the effect of a driving speed imparted by the second motorised means, which is greater than or equal to a driving speed imparted by the first motorised means. As the means of detection are for their own part composed of an angular position sensor of the arm, for correlative slaved actuation of the first and of the second driving means.

It should be noted that the arm forms moreover and advantageously an intermediate guiding member for the band during printing inside the reserve chamber, between two concurrent orientations, in order to limit the space requirements thereof.

The angular position detection sensor of the arm is for example a reflective opto-coupler which may be fixed indifferently on either member including the chassis and the arm, facing respectively either of said members. Such a sensor enables continuous delivery of a piece of information relative to the angular position of the arm.

According to another aspect of the present invention, the delivery mouth is arranged downstream of a voucher evacuation mouth provided at the outlet of the reserve chamber. A voucher flatness defect detection sensor is provided between the delivery and evacuation mouths. This sensor is also for instance a reflective opto-coupler. The purpose of these provisions is to cause reverse conveying of the voucher by the second driving means towards a storage receptacle, should the delivery mouth be clogged. This reverse conveying is performed by dint of selective guiding means of the voucher between the conveying thereof towards the evacuation mouth and the reverse conveying thereof towards the storage receptacle. These provisions are such that should the delivery mouth be clogged, the voucher subjected to deformation is evacuated towards the storage receptacle, so as not to disturb the operation of the device.

It should be understood that preferably such reverse conveying may be triggered during the printing process of the band. In such a case, the flatness defect detection sensor of the voucher causes the printing mechanism to stop, and actuates the second driving means, first of all to move the band tensioning member towards the cutting member in order to separate the voucher, and conveys the latter towards the delivery mouth, then causes reverse displacement of the voucher towards the storage receptacle.

The selective guiding means include in particular a first ramp which forms advantageously a lower wall of the reserve chamber, to guide the voucher towards the evacuation mouth as it is conveyed towards the delivery mouth, and if necessary, towards the storage receptacle, should the latter be clogged.

Preferably, third driving means of the voucher are interposed between the second driving means and the storage receptacle, to terminate the conveying of the voucher towards the latter after being released from the second motorised means. The implementation of the third driving means being preferably placed under the control of the slaving means, the driving speed of the voucher by these third driving means is greater than or equal to the driving speed of the voucher by the second driving means for maintaining the voucher under tension as it is conveyed towards the storage receptacle.

The third driving means are preferably fitted with a second ramp prohibiting undesirable return of the voucher from the storage receptacle towards the second driving means.

It should be noted that the implementation of the third driving means of the voucher is placed in particular under the control of a sensor detecting completed conveying of the voucher towards the storage receptacle, to authorise then the start of a new cycle for printing the band and for delivering the voucher.

These provisions are such that in addition to a normal delivery cycle of a printed voucher provided by the process of the present invention, it is also suggested, should the evacuation mouth be clogged, to perform the following sequential operations:

*) detecting a significant flatness defect of the band during the printing process at the outlet of the evacuation mouth outside the reserve chamber,

*) interrupting the printing process and separating the voucher from the band, then evacuating totally the voucher outside the reserve chamber,

*) reversing the driving direction of the voucher by the second motorised means and causing the implementation of the third driving means,

*) detecting the rejection of the voucher inside a storage receptacle, and caused the second motorised means to stop until the start of a new delivery cycle of a voucher.

The second driving means are in particular mainly composed of a couple of rolls bearing against one another resiliently, between which the band circulates and whereof one at least is motorised. Any of these rolls is advantageously supported by an access cover to the band for loading purposes. This access cover supports moreover any of the printing head and of a back-up roll co-operating therewith, which partake of the printing mechanism.

These provisions are such that the opening of the cover for loading a band roll enables to access the pathway thereof, through the printing mechanism as well as through the reserve chamber.

According to a preferred embodiment of the cutting member, the latter is a knife which includes a bevelled blade whereof the edge is arranged as a dihedron for gradual cut of the band as it is applied against the knife. This blade includes more particularly at each of its lateral ends a crank to provide end lateral lugs in the voucher, in order to be held by the second driving means upon completed conveying towards the evacuation mouth.

The present invention will be understood better, and details thereof will appear in the following description of a preferred embodiment, in conjunction with the figures of the appended drawings wherein:

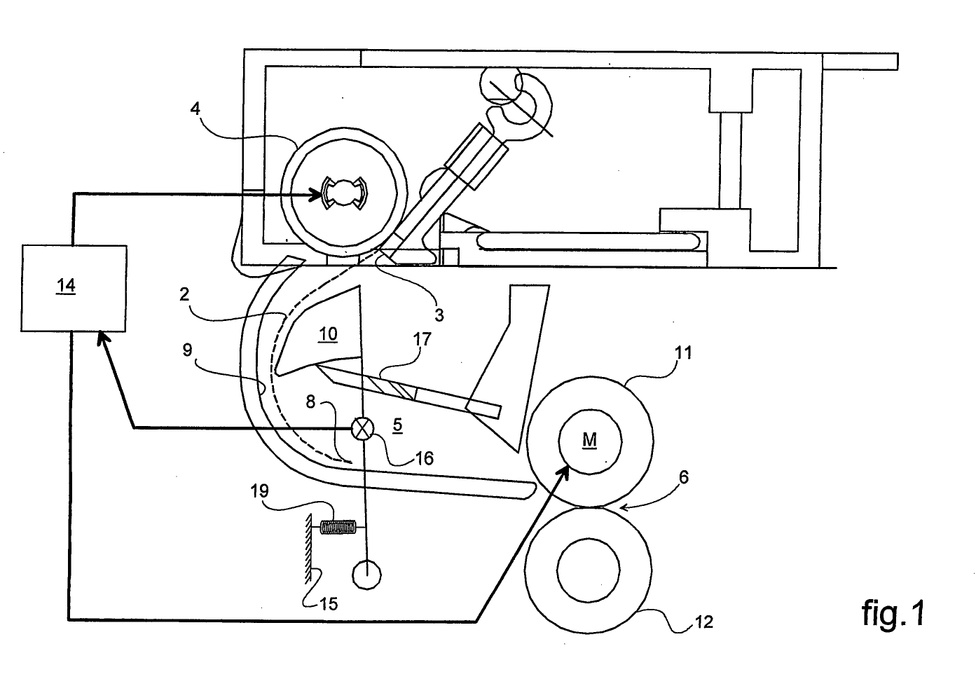

FIGS. 1, 2, and 3 are middle sectional schematic views of the upstream portion of a device according to the present invention, illustrating successively its operating modalities during a printing and cutting operation of the band, for delivering a voucher.

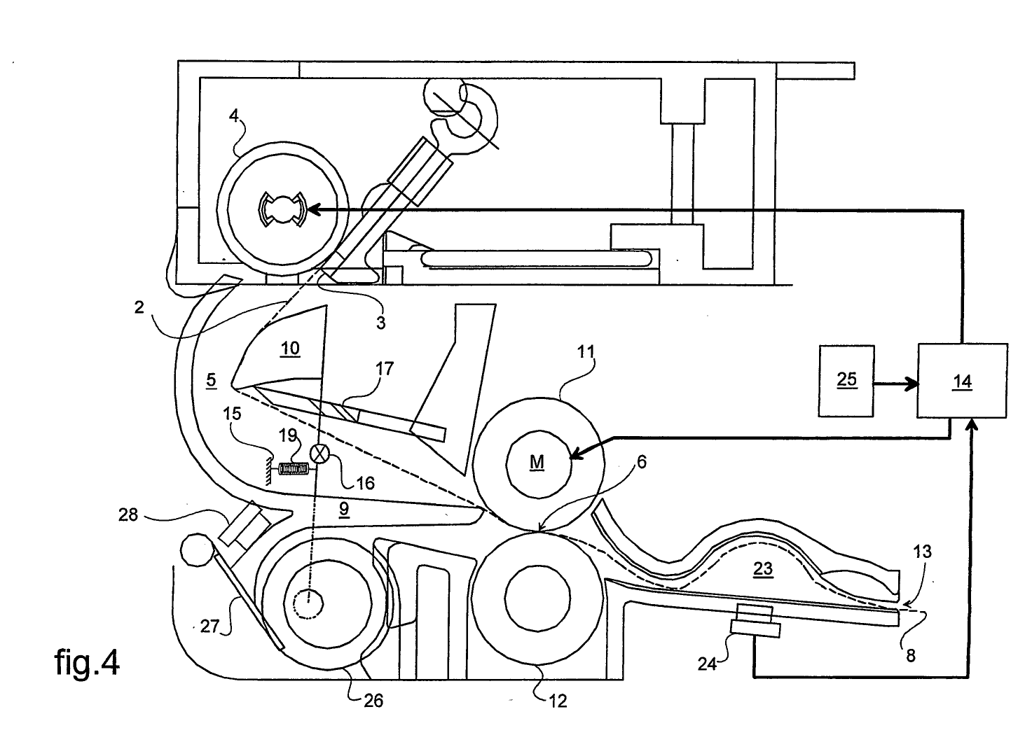

FIGS. 4, 5, 6 and 7 are middle sectional schematic views of a same device according to the present invention, illustrating successively its operating modalities should the voucher delivery mouth be clogged.

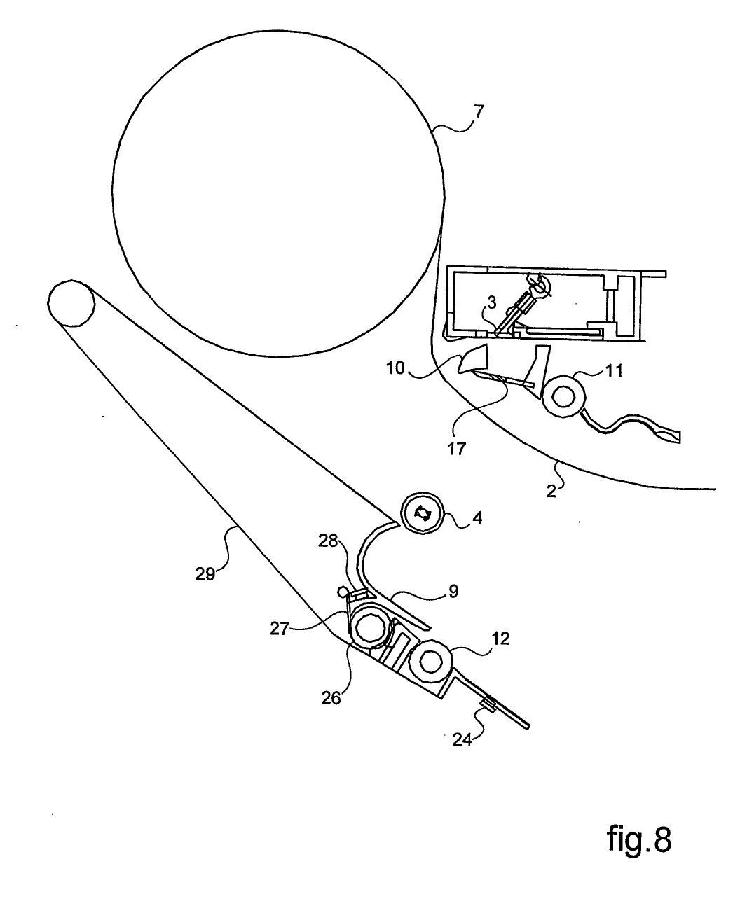

FIG. 8 is a middle sectional schematic view of the device represented on the previous figures, illustrating the loading of the band to be printed.

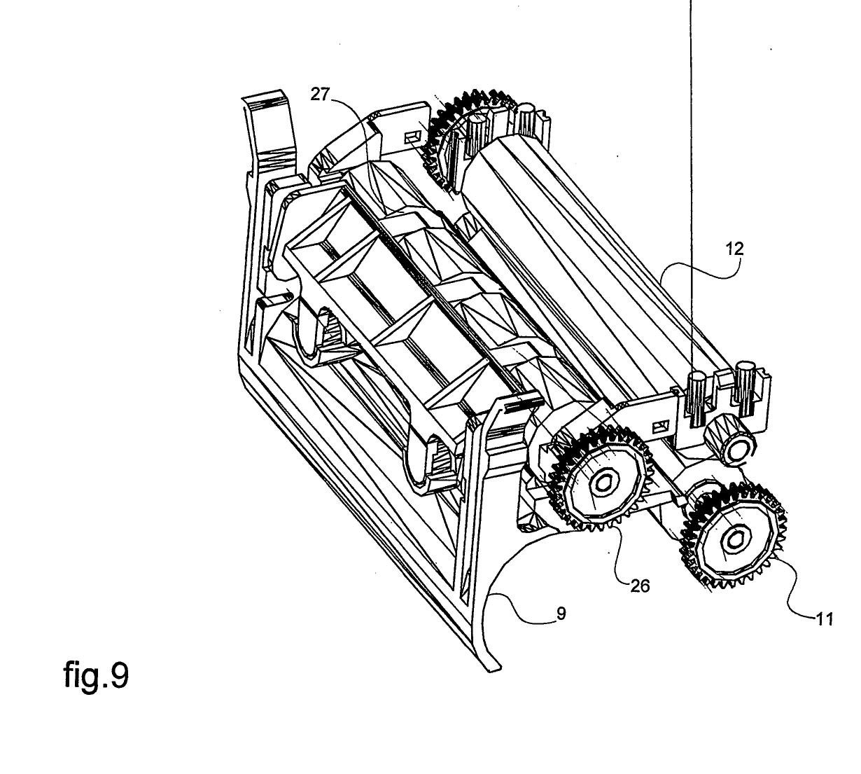

FIG. 9 is a bottom perspective view of a module partaking of the embodiment example of a device represented on the previous figures, illustrating the means for driving the band and for conveying a voucher should the delivery mouth be clogged.

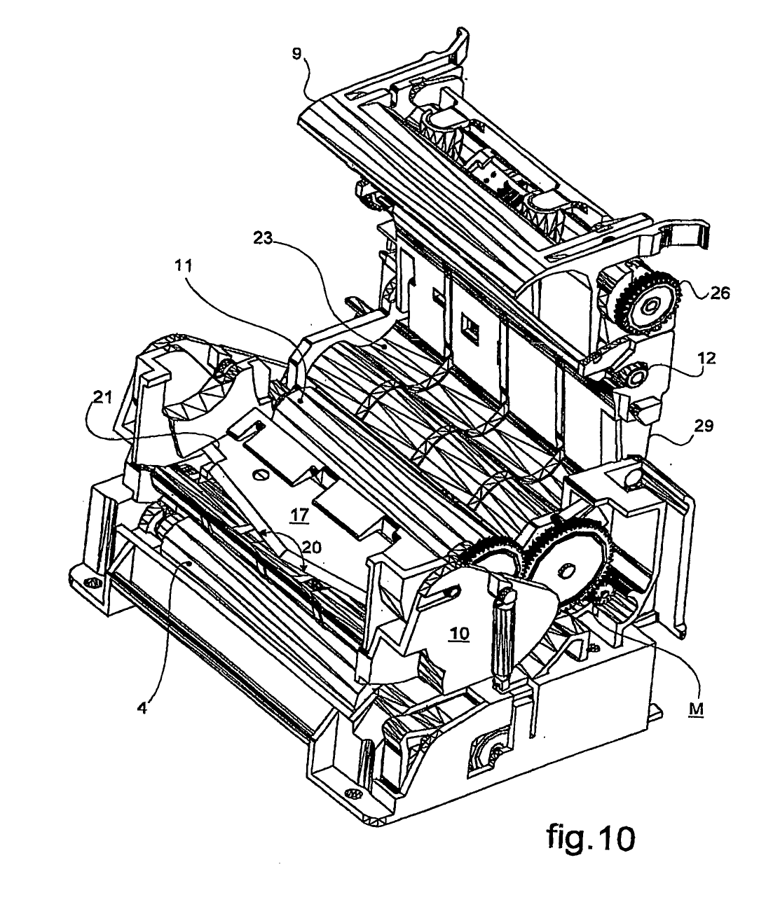

FIG. 10 is a bottom perspective view of the device according to the invention almost in its entirety, according to the embodiment example of the previous figure.

FIGS. 1, 2 and 3 show a device intended for delivering a printed voucher 1 from a band reserve 2 packaged into a roll 7, comprising at the outlet of a thermal printing mechanism a reserve chamber 5 inside which the band 2 being printed circulates, until a mouth 6 for evacuation of the band 2 out of said chamber 5.

On FIG. 1, the downstream end 8 of the band 2 is conveyed by a roll 4 pressing the band against a printing head 3, partaking of the printing mechanism. This back-up roll 4 is motorised to form first motorised means for driving the band 2 into the reserve chamber 5, situated below the printing mechanism. As it is printed, the band 2, driven by said first motorised means 4, circulates through the reserve chamber 5 while being guided initially by a first ramp 9, at the outlet of the printing mechanism, than by an arm 10 holding the band 2 under tension throughout the printing thereof. When the printed length of band 2 reaches the evacuation mouth 6, while being guided along the first ramp 9, the downstream end 8 of the band is sucked in by a couple of driving rolls 11, 12. These rolls 11, 12 form second motorised means for driving the band 2, which convey said band 2 out of the reserve chamber 5 towards a delivery mouth 13, not represented on these Figures.

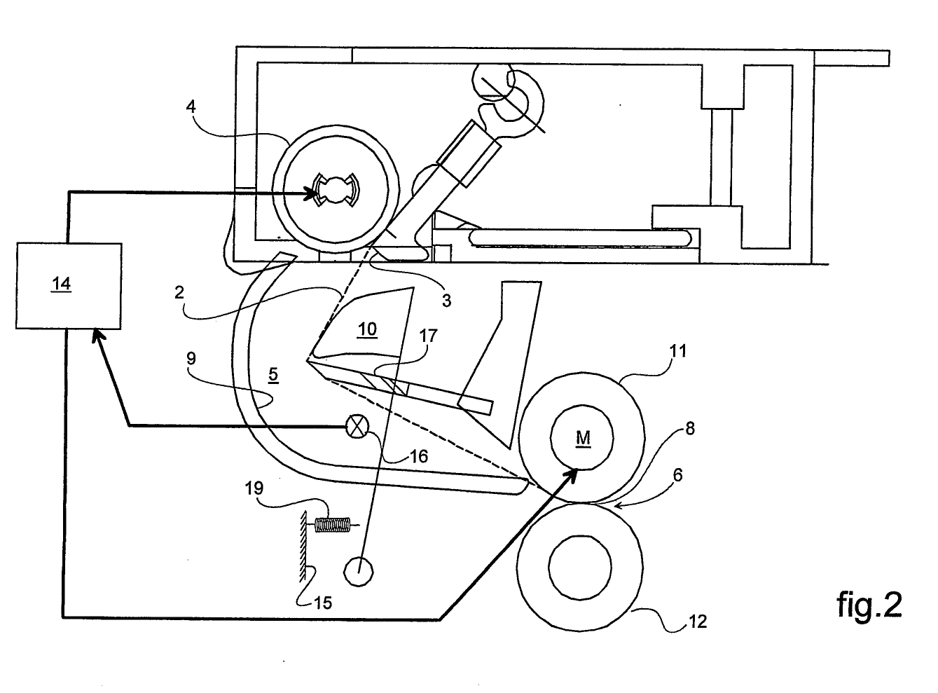

Slaving means 14 control and regulate the speeds of the driving rolls 11, 12 relative to the rotation of the back-up roll 4 when printing the band 2. The arm 10 is mounted resiliently and rotatably on a chassis 15, opposing the tension applied by the band 2 conveyed towards the evacuation mouth 6. A sensor 16 detecting the angular position of the arm 10 is in relation with the slaving means 14, for stabilising the arm 10 during the printing process of the band 2 in an intermediate position represented on FIG. 2.

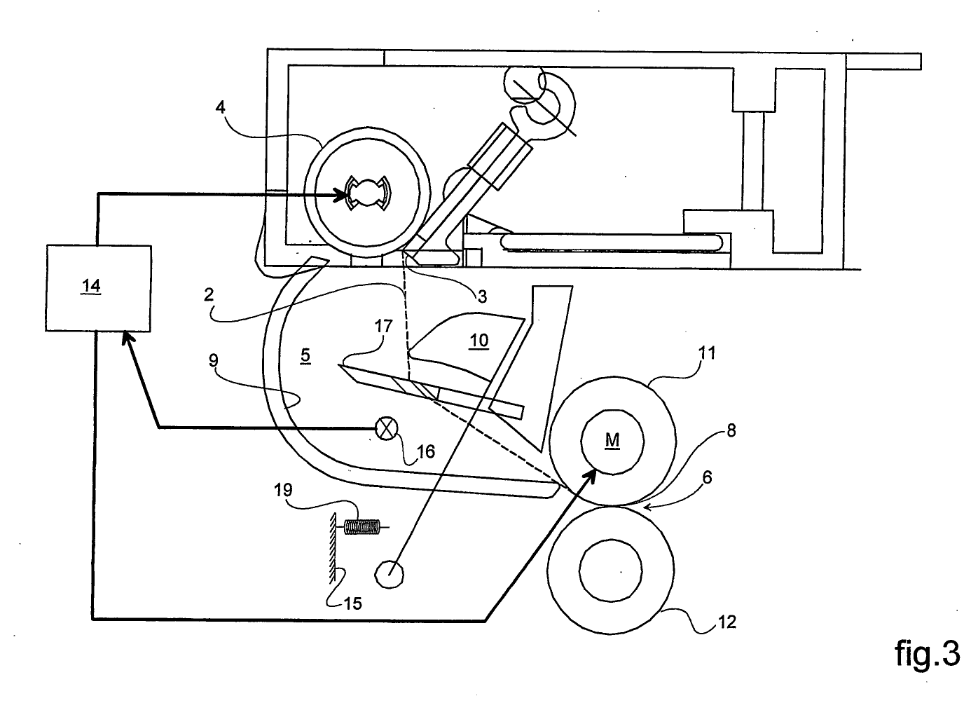

When the printing is complete, the slaving means 14 send a printing end control to the rolls 11, 12, which drive the printed band 2, the speed of the first driving means 4 being in particular zero by reason of the printing of the band 2 being complete. It should be noted that this speed of the driving rolls 11, 12 is preferably greater than that corresponding to the printing stage of the band 2 tending to stabilise the arm 10 in intermediate position. The length of the printed band 2 contained in the reserve chamber 5 tends to be reduced and the arm 10 tilts, under the tension effect applied by the band 2 driven by the rolls 11, 12 to accompany said band 2 towards a knife 17. In a final position of the arm 10, the band 2 is pressed against the knife 17, in order to separate the voucher 1 as represented on FIG. 3, which is conveyed through the evacuation mouth 6, until its upstream end 18 is engaged between the driving rolls 11, 12. It should be observed that the evacuation mouth 6 is formed by the contact zone between the driving rolls 11, 12. It will also be noted that the separation of the voucher 1 releases the arm 10, which tilts into initial position under the effect of the resilient means 19 wherewith it is equipped, corresponding to a beginning of a printing cycle.

While referring moreover to FIG. 10, one will notice the dihedral shape of the edge 20 of the blade forming the knife 17, for gradual cutting of the band 2. Moreover, the lateral ends of said blade 17 include cranks 21 in order to provide at the upstream end 18 of the voucher 1, lateral lugs through which it remains engaged between the driving rolls 11, 12, before being retracted by the user. It will be noted that this retraction is made easy nevertheless thanks to the small engagement surface of the voucher 1 by the rolls of the second driving means 11, 12, by dint of the lateral lugs that it contains.

It will be noted at this stage of the description that prolonged engagement of the voucher 1 by its upstream end 18 by the driving rolls 11, 12, causes said voucher to be rejected towards a storage receptacle 22, as described below.

On FIG. 4, the downstream end 8 of the band 2 is delivered during the printing cycle to a used, out of the reserve chamber 7 towards an intermediate chamber 23, then through the delivery mouth 13. This intermediate chamber 23, delineated on both sides by the evacuation 6 and delivery 8 mouths, houses a sensor 24 for detecting a flatness defect of the voucher 1, which may be causes in particular by the delivery mouth 13 being clogged persistently. It will be understood that such clogging causes deformation of the voucher 1, into a loop in particular, whereas the absence of clogging leaves the voucher 1 in substantially flat shape. It will also be noted at this stage of the description that the sensor 24 for detecting the flatness defect of the voucher 1 is used for causing the rejection thereof in case of lengthy presence, as aforementioned. It will be understood finally that the flatness defect clogging detection of the voucher 1 is associated preferably with chronometric means 25, to validate the clogging as significant from previously memorised reference duration.

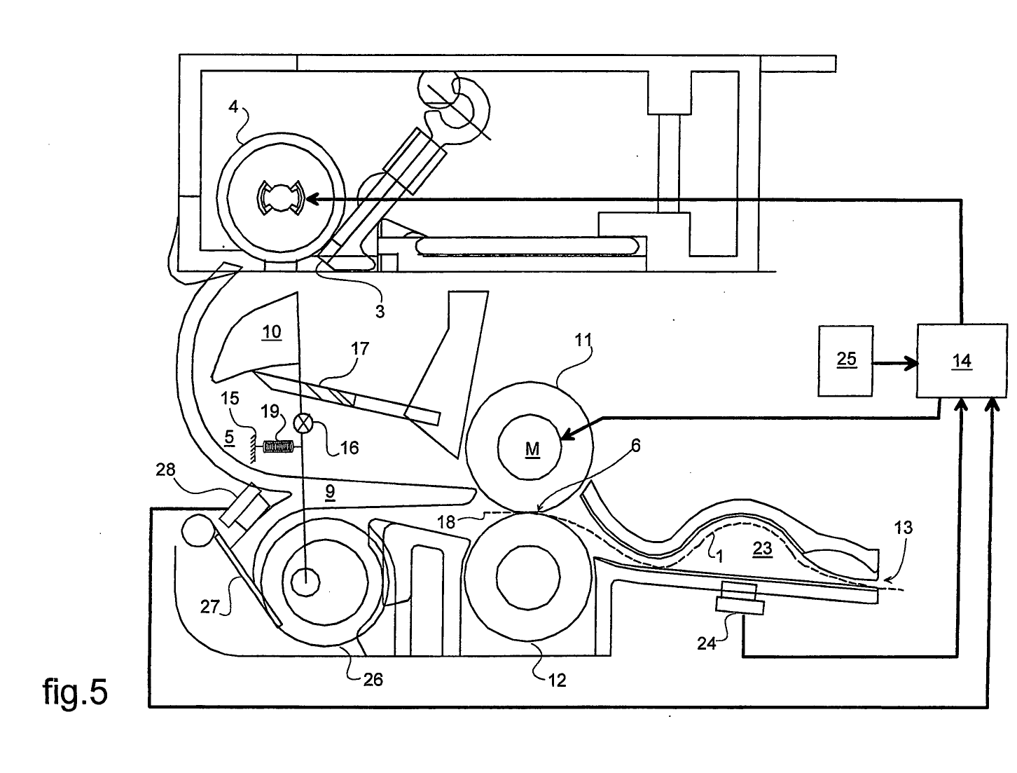

In a first stage, the sensor 24 for detecting a flatness defect communicates troublesome operation information to the slaving means 14, which stop the printing of the band 2, control the separation of the voucher 1 and the conveying thereof until engagement of its upstream end 18 between the driving rolls 11, 12 as described previously and represented on FIG. 5.

In a second stage, the slaving means 14 reverse the rotation direction of the driving rolls 11, 12, to convey the voucher 1 beneath the lower wall of the reserve chamber 5 formed by the first ramp 9, towards a motorised roll forming third means 26 for driving the voucher 1 towards a storage receptacle 22.

A second ramp 27 is provided at the base of the first ramp 9, to prevent the upstream end 18 of the voucher 1 from returning towards the second driving means 11, 12, let alone towards the reserve chamber 5. This second ramp 27 is advantageously shaped into a comb whereof the teeth are flush with the periphery of the roll 27 forming the third driving means.

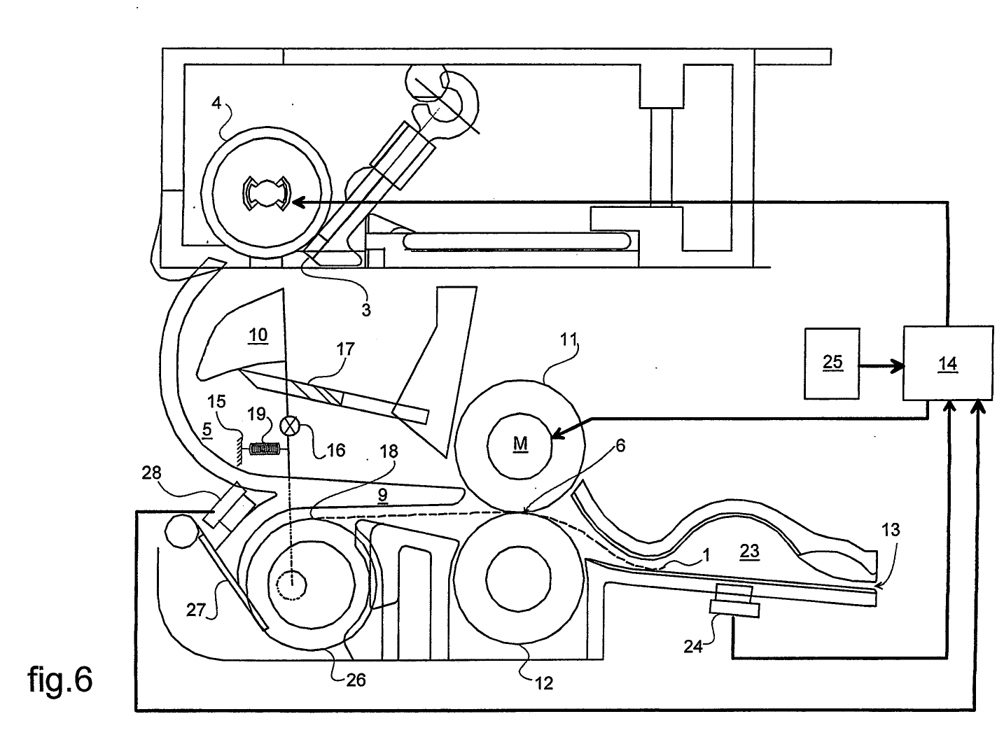

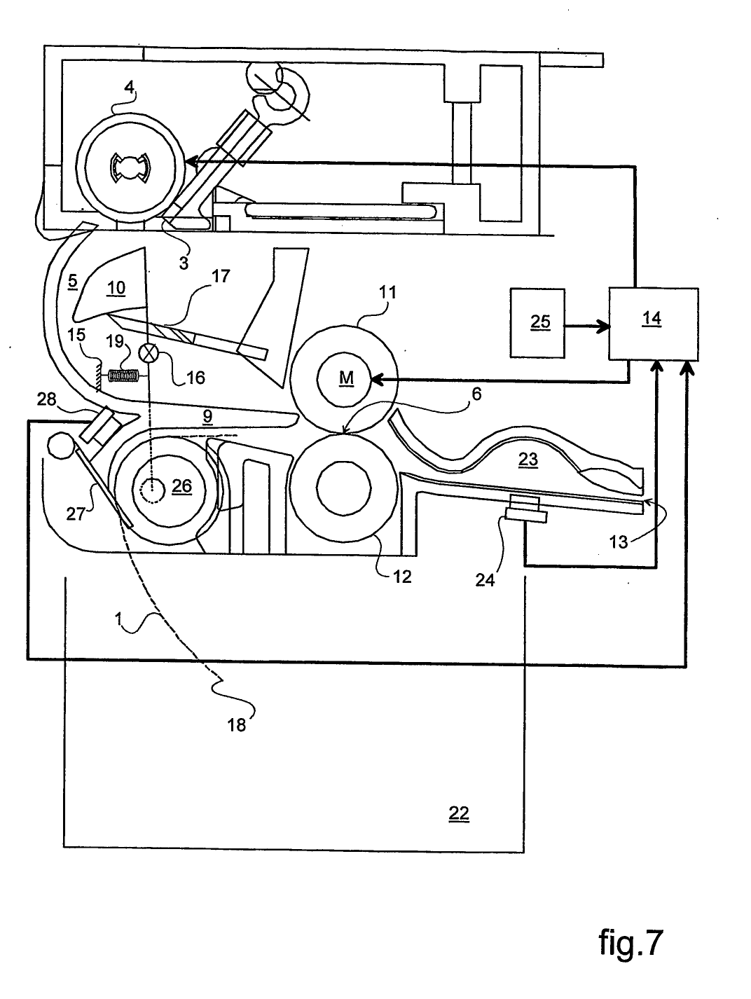

On FIGS. 6 and 7, the voucher 1 rejected is being conveyed towards the storage receptacle 22. A presence sensor 28 of the rejected voucher 1 senses the end of the conveying, to control the stop of the reversing motion of the rotation of the rolls 11, 12 partaking of the second driving means and the authorisation of the beginning of a new cycle, by dint of the slaving means 14.

On FIG. 8, the members of the device of the invention are distributed on both sides of the pathway of the band 2 running through said device. More particularly, a first set of members, including the thermal printing head 3, the pivoting arm 10, the knife 17 and one of the driving rolls 11, is supported fixedly to the chassis 15. A second set, comprising the back-up roll 4, the lower wall of the reserve chamber 5 formed by the first ramp 9, the roll 26 forming the third driving means and the other roll 12 of the second driving means, is supported by an opening cover 29, providing easy access to the compartment of the chassis 15 reserved for the band roll 2, and to the pathway of the band 2 through the device of the invention. These arrangements are such that for replacing an empty band roll 7, the handling of the 2, for circulation through the device of the invention, is made easier.

With reference moreover to FIG. 10, one will observe the distribution of both these set of members, and notably the second set mounted on the opening cover 29 hinged on the chassis 15. On FIG. 9, one will note that the tilting of the cover 29 into closing position places both rolls of the second driving means 11, 12 in contact with one another. To this end, the members comprising the second set are mounted on a same add-on mode on the cover 29 by nesting thereon.

1. Device for feeding a band in order to deliver for a user a printed voucher generated from said band, said device being arranged to co-operate with a printing mechanisms, such a thermal printing mechanism, which comprises first motorised means for driving the printable band packaged into a roll, from a reserve to a printing head, said device being arranged in order to allow user's access to the portion of band during printing by circulating through the delivery mouth during the printing process thereof, such a device comprising mainly:
*) a chassis fitted with a mouth for delivering the voucher for the user and connected to the printing mechanism,
*) a chamber storing a portion of band during printing, which is interpose between the printing mechanism and the delivery mouth,
*) optionally, a cutting member for the separation of the voucher beyond the band,
further comprising means for slaving the speeds driving the band during printing, driving the band jointly by the first motorised means and by second motorised positive driving means of the band located inside the reserve chamber, for causing simultaneous and regulated implementation of the first and second driving means relative to one another, the implementation of said slaving means being placed under the control of means for detecting the position of an elastic mobile member for maintaining under tension the band inside the reserve chamber, opposing the driving thereof by the second driving means, a position which varies according to the relative driving speeds of the band, respectively by the first and by the second driving means.

2. A device according to claim 1,
wherein the cutting member is arranged inside the reserve chamber in a fixed position relative to the mobile member maintaining the band under tension, the voucher being separated by positive driving of the band by the second motorised means towards the cutting member, opposing the elastic mobility of the member maintaining the band under tension.

3. A device according to claim 1, wherein the member maintaining the band under tension is mainly composed of an arm mounted resiliently and rotatably on the chassis, opposing a tension applied by the printed arm to the arm under the effect of a driving speed imparted by the second motorised means, which is greater than or equal to a driving speed imparted by the first motorised means, as the means of detection are for their own part composed of a angular position sensor of the arm, for correlative slaved actuation of the first and of the second driving means.

4. A device according to claim 3, wherein the arm forms moreover an intermediate guiding member for the band during printing inside the reserve chamber between two concurrent orientations.

5. A device according to claim 3,
wherein the angular position detection sensor of the arm is a reflective opto-coupler which may be fixed indifferently on either member including the chassis and the arm, facing respectively either of said members.

6. A device according to
claim 1, wherein the delivery mouth is arranged downstream of a voucher evacuation mouth provided at the outlet of the reserve chamber whereas a voucher flatness defect detection sensor is provided between the delivery and evacuation mouths, to cause reverse conveying of the voucher by the second driving means towards a storage receptacle, by dint of selective guiding means of the voucher between the conveying thereof towards the evacuation mouth and the reverse conveying thereof towards the storage receptacle.

7. A device according to claim 6,
wherein the selective guiding means include a first ramp which forms a lower wall of the reserve chamber, to guide the voucher towards the evacuation mouth as it is conveyed towards the delivery mouth, and if necessary, towards the storage receptacle should the delivery mouth be clogged.

8. A device according to
claim 6, wherein third driving means of the voucher are interposed between the second driving means and the storage receptacle, to terminate the conveying of the voucher towards the latter after being released from the second motorised means the implementation of the third driving means being placed under the control of the slaving means so that their driving speed of the voucher is greater than or equal to the driving speed of the voucher by the second driving means, for maintaining said band under tension as it is conveyed towards the storage receptacle.

9. A device according to claim 8,
wherein the third driving means are fitted with a second ramp prohibiting undesirable return of the voucher from the storage receptacle towards the second driving means.

10. A device according to claim 8,
wherein the implementation of the third driving means of the voucher is placed under the control of a sensor detecting completed conveying of the voucher towards the storage receptacle.

11. A device according to
claim 1 wherein the second driving means being mainly composed of a couple of rolls bearing against one another resiliently, between which the band circulates and whereof one at least is motorised, any of these rolls is supported by a cover for access to the reserve of band for loading purposes, said cover supporting moreover any of the printing head and of a back-up roll co-operating therewith, which partake of the printing mechanism,
so that the opening of the cover for loading a band roll enables to access the pathway thereof, through the printing mechanism as well as through the reserve chamber.

12. A device according to
claim 1, wherein the cutting member is a knife which includes a bevelled blade whereof the edge is arranged as a dihedron for gradual cut of the band as it is applied against the knife, this blade including at each of its lateral ends a crank to provide end lateral lugs in the voucher, in order to be held by the second driving means upon completed conveying towards the evacuation mouth, while enabling easy removal by the user.

13. A method for delivering a printed voucher implementing a device according to claim 2,
which consists sequentially:
*) in conveying the portion of band during printing, simultaneously by the first and the second driving means towards and through the delivery mouth ,
*) in conveying the band at the end of the printing process by the second driving means, towards the cutting member to cause the separation of the voucher , and
*) in evacuating by the second driving means the voucher out of the reserve chamber, while maintaining said voucher, to make it available to the user.

14. A method for delivering a printed voucher according to claim 13,
which consists sequentially:
*) in detecting a significant flatness defect of the band during the printing process at the outlet of the evacuation mouth outside the reserve chamber,
*) in interrupting the printing process and separating the voucher from the band , then evacuating the voucher totally outside the reserve chamber,
*) in reversing the driving direction of the voucher by the second motorised means and causing the implementation of the third driving means.
*) in detecting the rejection of the voucher inside a storage receptacle, and caused the second motorised means to stop until the start of a new delivery cycle of a voucher.

15. A device according to claim 2, wherein the member maintaining the band under tension is mainly composed of an arm mounted resiliently and rotatably on the chassis, opposing a tension applied by the printed arm to the arm under the effect of a driving speed imparted by the second motorised means, which is greater than or equal to a driving speed imparted by the first motorised means, as the means of detection are for their own part composed of a angular position sensor of the arm, for correlative slaved actuation of the first and of the second driving means.

16. A device according to claim 7, wherein third driving means of the voucher are interposed between the second driving means and the storage receptacle, to terminate the conveying of the voucher towards the latter after being released from the second motorised means the implementation of the third driving means being placed under the control of the slaving means so that their driving speed of the voucher is greater than or equal to the driving speed of the voucher by the second driving means, for maintaining said band under tension as it is conveyed towards the storage receptacle.

17. A method for implementing a device according to claim 6, which consists sequentially:
*) in detecting a significant flatness defect of the band during the printing process at the outlet of the evacuation mouth outside the reserve chamber,
*) in interrupting the printing process and separating the voucher from the band, then evacuating the voucher totally outside the reserve chamber,
*) in reversing the driving direction of the voucher by the second motorised means and causing the implementation of the third driving means.
*) in detecting the rejection of the voucher inside a storage receptacle, and caused the second motorised means to stop until the start of a new delivery cycle of a voucher.
